(19) United States
(12) Patent Application Publication
(10) Pub. No.: US 2007/0290572 A1
(43) Pub. Date: Dec. 20, 2007

(54) Micro-electro mechanical system device using in-plane motion

(75) Inventors: Yong-hwa Park, Yongin-si (KR); Jun-o Kim, Yongin-si (KR); Jin-ho Lee, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/708,633

(22) Filed: Feb. 21, 2007

(30) Foreign Application Priority Data
Jun. 14, 2006 (KR) 10-2006-0053552

(51) Int. Cl. H02N 1/00

(52) U.S. Cl. 310/309

(57) ABSTRACT

A micro-electro mechanical system (MEMS) device using in-plane motion is provided. The MEMS device includes a stage which is supported by an axle and an actuator which provides a push-pull exciting force to the axle at upper and lower eccentric positions of an axis of the axle. The actuator includes a plurality of fixed combs; a plurality of driving combs for engagement with the fixed combs, the driving combs being translationally vibrated between engaging and disengaging positions by an electrostatic attractive force periodically generated by the fixed combs; a driving frame which connects and supports the driving combs, the driving frame being vibrated together with the driving combs; and a motion transmitting member transmitting the translational vibration of the driving frame to the eccentric positions of the axle. With this MEMS device, the comb structure can be easily expanded to improve the dynamic performance and high-speed/long displacement characteristic.

### CROSS-REFERENCE TO RELATED PATENT APPLICATIONS

This application claims priority from Korean Patent Application No. 10-2006-0053552, filed on Jun. 14, 2006, in the Korean Intellectual Property Office, the disclosure of which is incorporated herein in its entirety by reference.

### BACKGROUND OF THE INVENTION

1. Field of the Invention

Apparatuses consistent with the present invention relate to an micro-electro mechanical system (MEMS) device using in-plane motion, and more particularly, to an MEMS device in which a comb structure providing power is separated from a stage and is arranged in a two-dimensional plane so as to improve the dynamic performance and high-speed/large displacement characteristics of the MEMS device by expanding the comb structure, and a mechanical lever structure and a motion converting mechanism are used to improve the operational efficiency of the MEMS device.

2. Description of the Related Art

In various technical fields related to display devices, laser printers, precise measuring instruments, precise machining devices, etc., much research is being carried out to develop a small-sized MEMS device that is manufactured using micro-machining technologies. For example, in a display device, an MEMS device is used as an optical scanner for reflecting or deflecting a scanning light beam onto a screen.

FIG. 1 is a perspective view of a related art MEMS device. The related art MEMS device includes a stage 50 operating in a vibration mode and an axle 55 supporting the stage 50 and allowing the stage 50 to swing. The axle 55 includes a plurality of driving combs 12 formed along a longitudinal direction. An outer frame 21 faces the axle 55 at a different height. The outer frame 21 includes a plurality of fixed combs 22a and 22b extending in parallel and interlocking with the driving combs 12 of the axle 55. The driving combs 12 and the fixed combs 22a and 22b are located adjacent to each other so as to electrostatically attract each other. For example, when a ground voltage is applied to the driving combs 12 and a driving voltage V is applied to the left-sided fixed combs (first fixed combs) 22a, the driving combs 12 are pulled toward the first fixed combs 22a, and thus the stage 50 is rotated counterclockwise. Next, when a driving voltage V is applied to the right-sided fixed combs (second fixed combs) 22b, the driving combs 12 are attracted toward the second fixed combs 22b and thus the stage 50 is rotated clockwise. That is, the stage 50 can be alternately swung in one direction and in the other direction by applying predetermined alternating current (AC) voltages to the first and second fixed combs 22a and 22b. For example, a laser beam incident on the stage 50 is deflected in a scanning direction.

Generally, the driving angle of an optical scanner is related to the size of a screen to be scanned. When a large displacement scanner having a large driving angle is used, a wide area can be scanned and thus a large screen can be provided. Referring again to FIG. 1, the rotation angle (scanning angle) of the stage 50 can be increased by extending the arrangement of the comb electrodes 12, 22a, and 22b in the direction of the axle 55. However, when the number of comb electrodes 12, 22a, and 22b increases, the total inertial mass of all rotary parts including the stage 50 increases. Furthermore, the rotational stiffness of the rotary parts should be increased in proportional to the inertial mass so as to maintain a particular resonant frequency. Therefore, the overall size of the MEMS device increases. As a result, there is a structural limit to improving the dynamic characteristics of a scanner by extending the comb electrode arrangement.

In order to drive the axle 55, the driving combs 12 are vibrated between an engaging position with the fixed combs 22a and 22b and a disengaging position from the fixed combs 22a and 22b. The driving combs 12 are spaced a predetermined distance apart from the fixed combs 22a and 22b, so that mechanical interference can be prevented between the driving combs 12 and the fixed combs 22a and 22b. As the driving combs 12 extend further in the radial direction of the axle 55, the possibility of interference between the driving combs 12 and the fixed combs 22a and 22b increases. Therefore, although the electrostatic force acting between the driving combs 12 and the fixed combs 22a and 22b can be increased to a certain degree by increasing the opposing area between the driving combs 12 and the fixed combs 22a and 22b, there are geometrical and physical limits to improving the dynamic characteristics of a scanner by increasing the opposing area between the driving combs 12 and the fixed combs 22a and 22b.

### SUMMARY OF THE INVENTION

The present invention provides a MEMS device that has a two-dimensionally arranged comb structure suitable for improving dynamic characteristics of the MEMS device by expanding the comb structure.

The present invention also provides an MEMS device in which a comb structure is separated from a stage in order to ensure high-speed and large-displacement operation.

The present invention further provides an MEMS device that has an efficient translation-rotational vibration converting mechanism.

The present invention further provides an MEMS device that has an efficient driving force amplifying structure using a mechanical lever structure.

According to an aspect of the present invention, there is provided an MEMS device including: a stage supported by an axle; and an actuator which provides a push-pull exciting force to the axle at upper and lower eccentric positions of an axis of the axle, wherein the actuator includes: a plurality of fixed combs extending in parallel at predetermined intervals; a plurality of driving combs formed at a predetermined location for engagement with the fixed combs, the driving combs being translationally vibrated between an engaging position and a disengaging position by an electrostatic attractive force periodically generated by the fixed combs; a driving frame connecting and supporting the driving combs, the driving frame being vibrated together with the driving combs; and a motion transmitting member which transmits the translational vibration of the driving frame to the eccentric positions of the axle.

According to another aspect of the present invention, there is provided an MEMS device including: a stage supported by an axle; and first and second actuators that are respectively located at first and second positions above and below an axis of the axle and apply forces to the axle in opposite directions, wherein each of the first and second actuators includes: a plurality of fixed combs extending at predetermined intervals in parallel to each other; a plurality of driving combs formed at a predetermined location for engagement with the fixed combs, the driving combs being translationally vibrated between an engaging position and a disengaging position by an electrostatic attractive force periodically generated by the fixed combs; a driving frame connecting and supporting the driving combs, the driving frame being vibrated together with the driving combs; and a lever frame interlocking with the driving frame through a first link so as to be rotationally vibrated about a hinged end; and a second link extending from one side of the lever frame toward the axle of the stage and coupled to the first position or the second position of the axle.

The lever frame may couple to the first link at a point located a distance L1 from the hinged end and to the second link at a point located a distance L2 from the hinged end, and the distance L1 may be greater than the distance L2.

The second link may extend from the lever frame, cross a centerline of the axle, and couple to a concave portion of the axle formed as corresponding to the second link.

Each of the first and second actuators may be coupled to both ends of the axle so as to periodically provide a push-pull exciting force to the first and second positions of the axle.

Each of the first and second actuators may be coupled to one end of the axle so as to periodically provide an exciting force to an eccentric position of the axle, and the other end of the axle may be fixedly supported.

According to a further another aspect of the present invention, there is provided an MEMS device including: a stage supported by an axle; and an actuator and a fixed frame that are respectively located at first and second positions above and below an axis of the axle and apply forces to the axle in opposite directions, wherein the first and second actuators includes: a plurality of fixed combs extending in one direction at predetermined intervals in parallel to each other; a plurality of driving combs formed at a predetermined location for engagement with the fixed combs, the driving combs being translationally vibrated between an engaging position and a disengaging position by an electrostatic attractive force periodically generated by the fixed combs; a driving frame connecting and supporting the driving combs, the driving frame being vibrated together with the driving combs; and a lever frame interlocking with the driving frame through a first link so as to be rotationally vibrated about a hinged end; and a second link extending from one side the lever frame toward the axle of the stage and coupled to the first position of the axle, wherein the fixed frame includes a fixed link coupled to the second position of the axle for applying a reaction force to the axle against a force applied from the actuator to the axle.

### BRIEF DESCRIPTION OF THE DRAWINGS

The above and other aspects of the present invention will become more apparent by describing in detail exemplary embodiments thereof with reference to the attached drawings, in which:

FIG. 1 is a perspective view illustrating the main parts of a related art MEMS device;

FIG. 2 is a view illustrating a planar structure of an MEMS device according to an exemplary embodiment of the present invention;

FIG. 3 is an enlarged view of a portion of the planar structure of the MEMS device illustrated in FIG. 2, according to an exemplary embodiment of the present invention;

FIG. 4 is a view schematically illustrating the MEMS device illustrated in FIG. 2 in order to explain an operation of the MEMS device according to an exemplary embodiment of the present invention;

FIGS. 5A and 5B are vertical cross-sectional views taken along a line V-V of FIG. 4 for explaining a translation-rotation converting mechanism according to an exemplary embodiment of the present invention;

FIG. 6 is an enlarged plan view illustrating a second link structure according to an exemplary embodiment of the present invention;

FIGS. 7A and 7B are vertical cross-sectional views taken along a line VII-VII of FIG. 6 for explaining deformation of the second link structure illustrated in FIG. 6 according to an exemplary embodiment of the present invention;

FIG. 8 is a view illustrating deformation of a cantilever corresponding to the deformation of the second link connection structure depicted in FIG. 7B, according to an exemplary embodiment of the present invention;

FIG. 9 is a plan view illustrating an example of a second link structure for comparison to the second link structure of the present invention;

FIGS. 10A and 10B are vertical cross-sectional views taken along a line X-X of FIG. 9 for explaining deformation of the link connection structure illustrated in FIG. 9, according to an exemplary embodiment of the present invention;

FIG. 11 is a view illustrating deformation of a cantilever corresponding to the deformation of the link connection structure depicted in FIG. 10B, according to an exemplary embodiment of the present invention; and

FIGS. 12 through 14 are plan views illustrating MEMS devices according to other exemplary embodiments of the present invention.

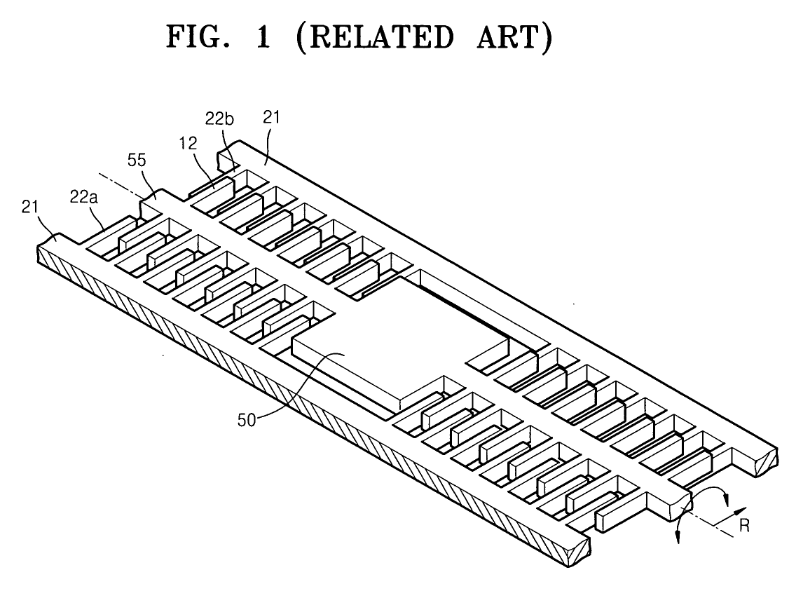

### DETAILED DESCRIPTION OF EXEMPLARY EMBODIMENTS

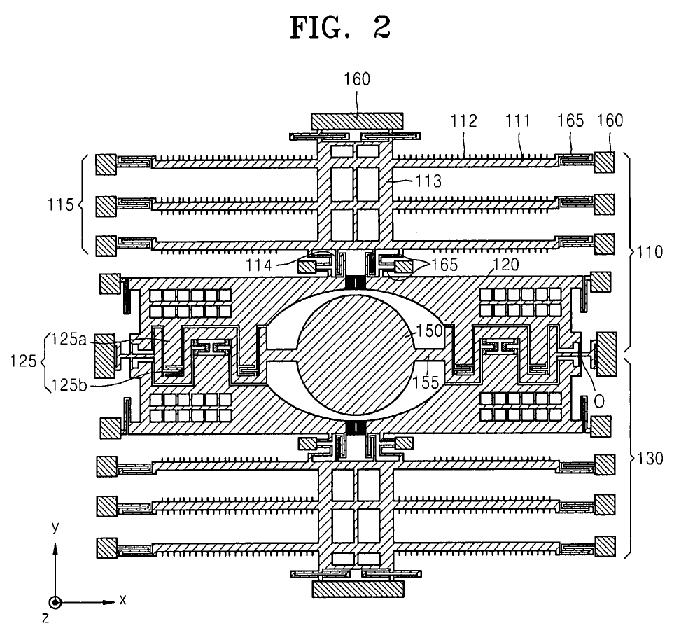

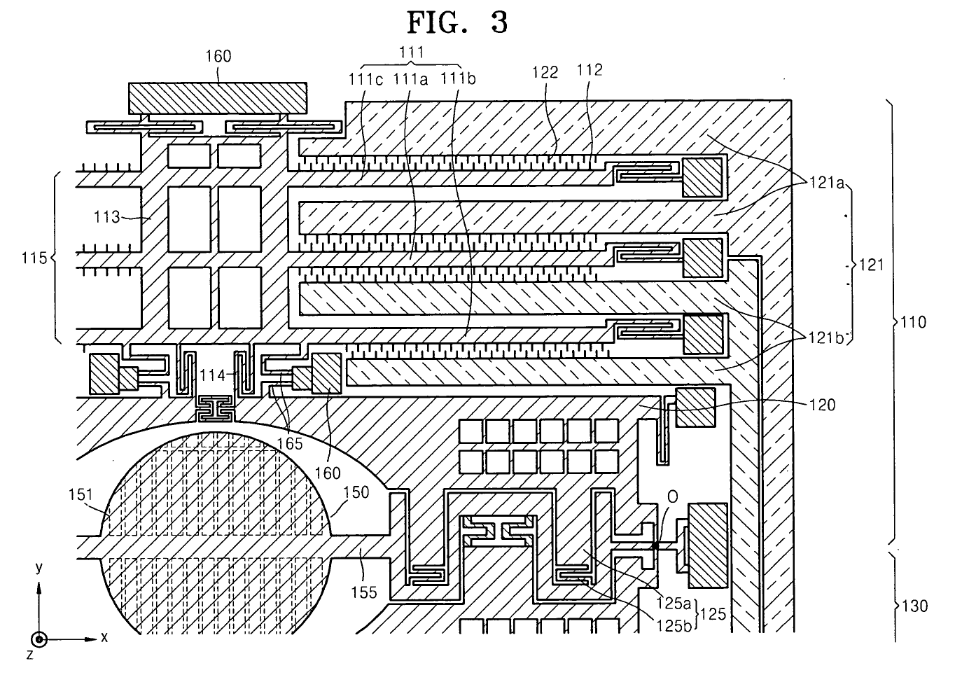

An MEMS device will now be described more fully with reference to the accompanying drawings, in which exemplary embodiments of the invention are shown. FIG. 2 is a view illustrating a planar structure of an MEMS device according to an exemplary embodiment of the present invention, and FIG. 3 is an enlarged view of a portion of the planar structure of the MEMS device illustrated in FIG. 2. In FIG. 2, some of an electrode structure is omitted for clarity. Referring to FIG. 2, the MEMS device according to an exemplary embodiment of the present invention includes a stage 150 supported by an axle 155, and a first actuator 110 and a second actuator 130 that rotate the stage 150. The first and second actuators 1 10 and 130 are symmetrical with respect to the axle 155 of the stage 150. Thus, the same reference numerals are used herein for symmetrical elements of the first and second actuators 110 and 130.

FIG. 3 is an enlarged view illustrating a portion of the first actuator 110 for explaining the electrode structure of the MEMS device depicted in FIG. 2. Referring to FIG. 3, the first actuator 110 includes a plurality of fixed electrodes 121 and a plurality of driving electrodes 111. The fixed electrodes 121 extend in an x-axis direction and are spaced a predetermined distance apart from each other, the driving electrodes 111 are disposed between the fixed electrodes 121. The fixed electrodes 121 and the driving electrodes 111 that are alternately disposed include a plurality of fixed combs 122 and a plurality of driving combs 112 that protrude in parallel to each other from their mutually facing surfaces towards opposite surfaces. That is, the fixed combs 122 perpendicularly protrude from the fixed electrodes 121 and are arranged along a longitudinal direction of the fixed electrodes 121, and the driving combs 112 protrude from the driving electrodes 111 and are arranged between the fixed combs 122. The driving combs 112 and the fixed combs 122 are adjacent to each other, so as to electrostatically attract each other. When a predetermined voltage is applied between the driving combs 112 and the fixed combs 122, the driving combs 112 are attracted toward the fixed combs 122. Therefore, the driving electrodes 111 where the driving combs 112 are formed can be translated in a positive or negative direction of the y-axis.

It is not always required that the combs 112 and 122 are formed on all the mutually facing surfaces of the driving electrodes 111 and the fixed electrodes 121. Instead, the combs 112 and 122 can be formed on one side or both sides of each of the electrodes 111 and 121 based on the relative arrangement between the electrodes 111 and 121. This will now be described in more detail below. In the description, surfaces of the electrodes 111 and 121 facing upward (in a positive y-axis direction) will be referred to as +y surfaces, and surfaces of the electrodes 111 and 121 facing downward (in a negative y-axis direction) will be referred to as −y surfaces. Referring again to FIG. 3, the driving electrodes 111 includes a central driving electrode 111a, an outer driving electrode 111c formed above the central driving electrode 111a in the positive y-axis direction, and an inner driving electrode 111b formed under the central driving electrode 111a in the negative y-axis direction. The driving combs 112 are formed both on +y and −y surfaces of the central driving electrode 111a. However, the driving combs 112 are formed only on a +y surface of the outer driving electrode 111c and on a −y surface of the inner driving electrode 111b. With this structure, electrostatic attractive forces can be alternately generated in opposite directions and thus the driving electrodes 111 can be translated both in ±y directions. Since electrostatic attractive forces can be applied between the driving combs 112 and the fixed combs 122 when the driving combs 112 and the fixed combs 122 face each other, the fixed combs 122 are formed on surfaces of the fixed electrodes 121 facing the driving combs 112.

Meanwhile, the fixed electrodes 121 and the driving electrodes 111 support the combs 122 and 112 and apply a driving voltage to the combs 122 and 112. The fixed electrodes 121 and the driving electrodes 111 may be sufficiently spaced apart so as to decrease electrostatic interaction, between the fixed electrodes 121 and the driving electrodes 111, to a negligible level. Therefore, a desired oscillation mode can be obtained by controlling the electrostatic attractive force between the associated combs 112 and 122 extending from the driving electrodes 111 and the fixed electrodes 121, respectively.

A constant voltage such as a ground voltage can be applied to the driving electrodes 111. The fixed electrodes 121 includes first fixed electrodes 121a located above the central driving electrode 111a in the +y direction and second electrodes 121b located under the central driving electrode 111a in the −y direction. A first AC voltage is applied to the first fixed electrodes 121a, and a second AC voltage having a different waveform from the first AC voltage is applied to the second fixed electrodes 121b. Alternatively, the first and second AC voltages may be provided in the form of sinusoidal AC pulses having the same amplitude and a half-cycle phase difference. When above-described driving voltages are applied, the first fixed electrodes 121a periodically attract the neighboring driving electrodes 111a and 111c in the +y direction, and the second fixed electrodes 121b periodically attract the neighboring driving electrodes 111a and 111b in the −y direction. This results in translational vibration of the driving electrodes 111 in ±y directions. Meanwhile, the driving electrodes 111 are supported and connected by a vertically extending connection bar 113. An entire driving frame 115 including the driving electrodes 111 and the connection bar 113 is also vibrated in a translational manner in the ±y directions.

The translational vibration of the driving frame 115 is transmitted to a lever frame 120 through first links 114. The first links 114 are a kind of meander spring transmitting a motion between the driving frame 115 and the lever frame 120. The first links 114 have a high rigidity in the y direction and a low rigidity in the x direction, so that the y direction vibration of the driving frame 115 can be directly transmitted to the lever frame 120 and rotational vibration of the lever frame 120 is never obstructed. For this, the first links 114 may be folded several times to allow extension and compression in the x direction and may have a high aspect ratio (narrow width). The lever frame 120 interlocks with the driving frame 115 through the first links 114, so that the lever frame 120 can be swung about a hinge (O) (rotational vibration) within a predetermined angle range. The hinge (O) of the lever frame 120 is formed on the axle 155 of the stage 150 and is commonly used for both lever frames 120 of the first and second actuators 110 and 130. The lever frames 120 of the first and second actuators 110 and 130 are swung in opposite directions, so that the hinge (O) can be a center of rotation due to self-equilibrium. For example, when the lever frame 120 of the first actuator 110 is pulled upward and the lever frame 120 of the second actuator 120 is pulled downward, the hinge (O) is at a fixed point by equilibrium of forces and serves as a center of rotation for the lever frames 120.

The rotational vibration of the lever frame 120 is transmitted to the axle 155 of the stage 150 through second links 125. For example, as the lever frame 120 is rotated clockwise about the hinge (O), the second links 125 apply an exciting force to the axle 155 in a pulling direction, and as the lever frame is rotated counterclockwise about the hinge (O), the second links 125 apply an exciting force to the axle 155 in a push direction. The axle 155 is twisted in one direction and the other direction while periodically receiving this push-pull exciting forces, so that the stage 150 can be swung. Each of the second links 125 may include a base portion 125a and a spring portion 125b that have different shapes and are arranged in a longitudinal direction of the second link 125. The spring portion 125b is folded several times so as to be extended and compressed in the y direction (the power transmitting direction). Furthermore, the spring portion 125b has a large thickness (high aspect ratio), so that the axle 155 can be supported rigidly without movement or bending in the x-axis and z-axis directions.

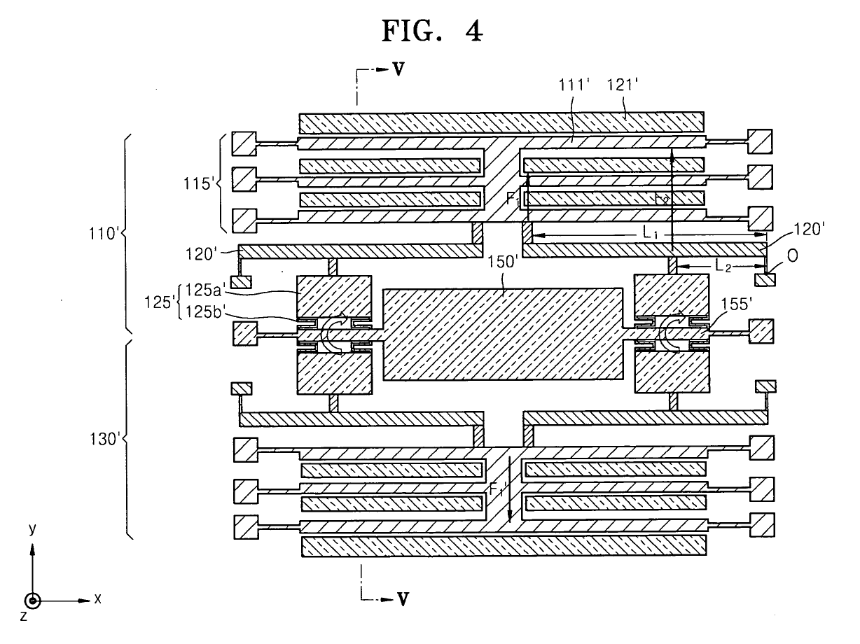

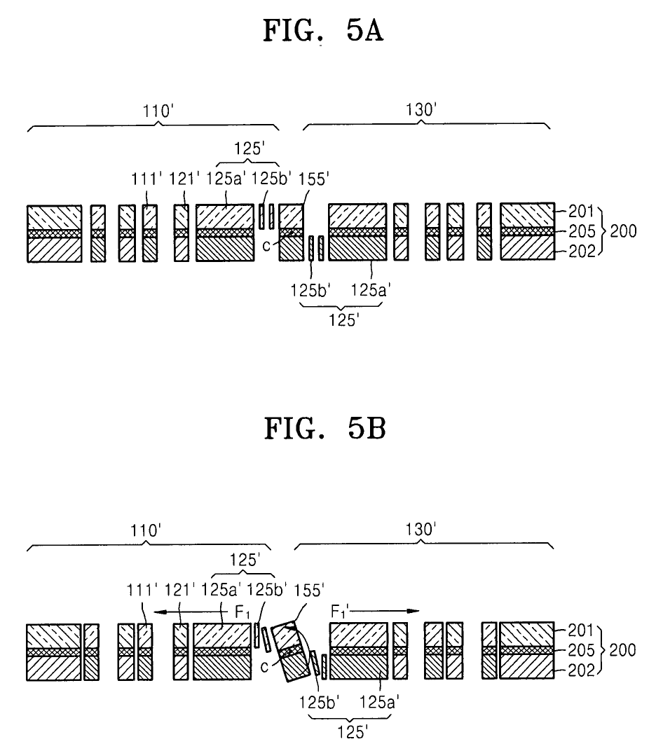

FIG. 4 is a schematic view illustrating an MEMS device according to an exemplary embodiment of the present invention, and FIGS. 5A and 5B are vertical cross-sectional views taken along a line V-V of FIG. 4. In FIGS. 5A and 5B, different rotational states are illustrated in order to explain a swinging motion of an axle 155′. Referring to FIGS. 4, 5A, and 5B, second links 125′ of a first actuator 110′ and second links 125′ of a second actuator 130′ are connected to the axle 155′ at different heights in the z-axis direction. That is, the second links 125′ of the first actuator 110′ extend to an upper portion of the axle 155′, and the second links 125′ of the second actuator 130′ extend to a lower portion of the axle 155′ as shown in FIGS. 5A and 5B, so that the axle 155′ can receive exciting forces F1 and F1′ in opposite directions from the second links 125′ of the first and second actuators 110′ and 130′. These push-pull type exciting forces F1 and F1′ act on the axle 155′ as a couple of forces with respect to a center (C) of the axle 155′, so that the axle 155′ can be twisted in one direction. The MEMS device according to the current exemplary embodiment of the present invention may include a silicon-on-insulator (SOI) substrate 200 that is patterned by etching. The SOI substrate 200 may include a first silicon substrate 201, a second silicon substrate 202, and an insulating layer 205 formed between the first and second silicon substrate 201 and 202. The second links 125′ or springing portions 125b′ of the second links 125′ may be formed into a single layer of the first silicon substrate 201 or the second silicon substrate 202, and most of the other elements, such as an electrode structure including fixed electrodes 121′ and driving electrodes 111′, the axle 155′ of an stage 150′, and a lever frame 120′, may be formed into multiple layers of the first and second silicon substrates 201 and 202. For example, the spring portions 125b′ of the first actuator 110′ may be formed of the first silicon substrate 201, and the spring portions 125b′ of the second actuators 130′ may be formed of the second silicon substrate 202. In this case, the spring portions 125b′ formed of the first silicon substrate 201 may be formed integrally with an upper portion of the axle 155′, and the spring portions 125b′ formed of the second silicon substrate 202 may be formed integrally with a lower portion of the axle 155′.

The lever frame 120′ increases power transmission efficiency. This will now be described in more detail with reference to FIG. 4. Referring to FIG. 4, a force is applied to the lever frame 120′ from a driving frame 115′ at a point located an input distance L1 from a hinge (O) and the lever frame 120′ transmits the applied force to the axle 155′ at a point located an output distance L2 from the hinge (O). When the lever frame 120′ receives an input force F1 and transmits an output force F2 to the axle 155′, the power transmitting relationship can be expressed by Equation 1 using the lever rule.

$$\frac{F 2}{F 1} = \frac{L 1}{L 2} \qquad [ Equation 1 ]$$

The lever frame 120′ is designed so that the input distance L1 is larger than the output distance L2 (L1/L2>1). Therefore, the force transmission ratio F2/F1 is larger than one (i.e., the output force F2 can be larger than the input force F1). That is, the force transmission ratio F2/F1 can be optimized by adjusting the input and output distances L1 and L2. In the exemplary embodiment of the present invention, the transitional displacement of the comb structure is transmitted to the axle 155′ of the stage 150′ instead of transmitting the transitional displacement directly to the stage 150′. Therefore, a relatively small displacement and a relatively large force are required when compared with the related art structure in which a stage is directly vibrated. For this reason, the lever structure is used to increase the force transmission ratio F2/F1, thereby improving operational characteristics of the stage 150′.

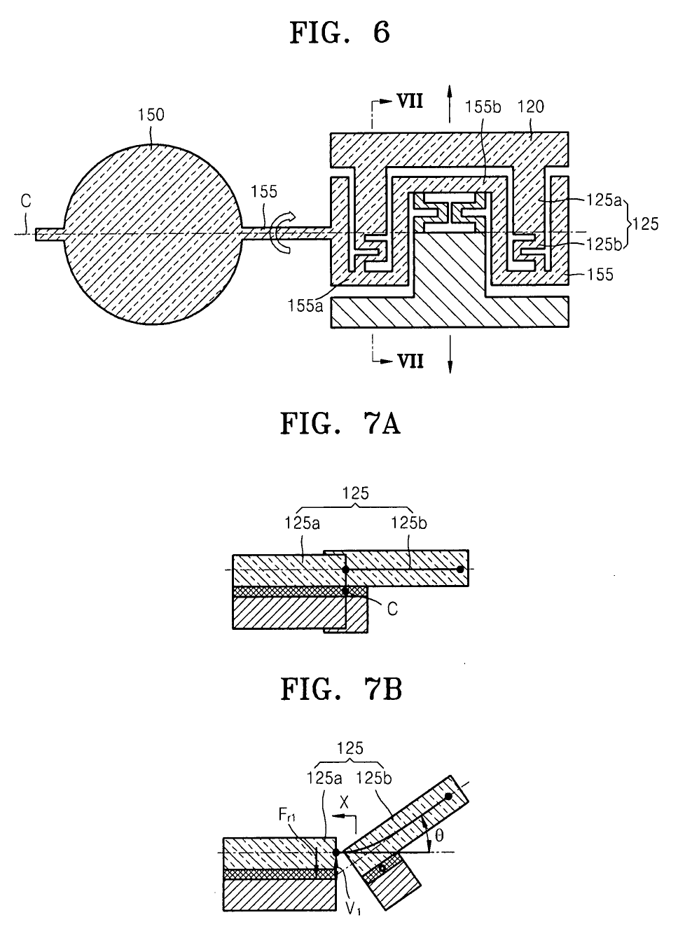

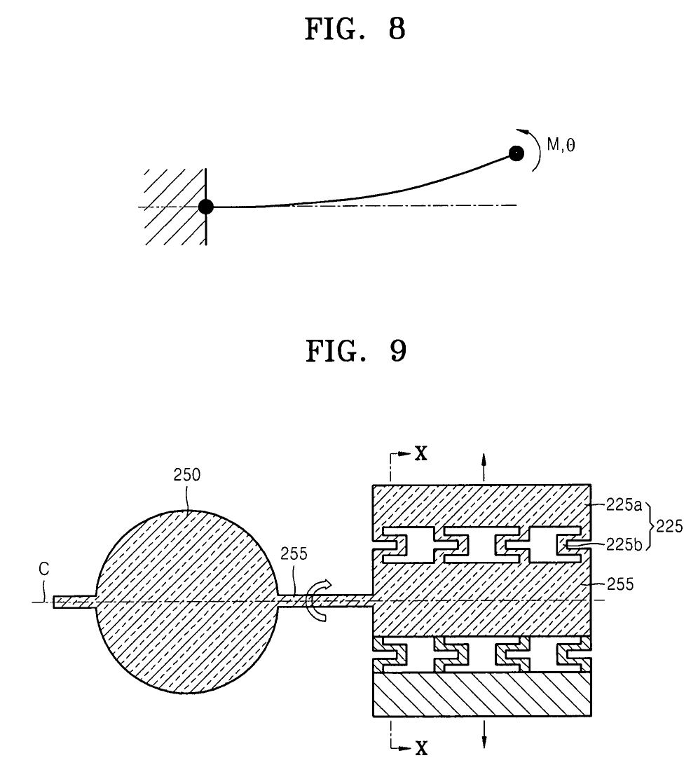

FIG. 6 is an enlarged view of a portion of the planar structure of the MEMS device illustrated in FIG. 3, in which a coupling structure of the axle 155 and the second links 125 are illustrated. As explained above, the second links 125 are connected between the lever frame 120 and the axle 155 in order to transmit power. In an exemplary embodiment of the present invention, the second links 125 extend from the lever frames 120 to first and second concave portions 155a and 155b of the axle 155 through a centerline C of the axle 155. In detail, the second links 125 of the first actuator 110 extend downward through the centerline C of the axle 155 and are connected to the first concave portions 155a, and the second links 125 of the second actuator 130 extend upward through the centerline C of the axle 155 to the second concave portion 155b. For this, the axle 155 has a folded shape at a portion corresponding to the second links 125. FIGS. 7A and 7B are vertical cross-sectional views taken along a line VII-VII of FIG. 6 and show the second link 125 before and after the axle 155 is rotated by a predetermined angle θ. In FIGS. 7A and 7B, when the second link 125 bends and thus the axle 155 is rotated, it is assumed for clarity that the bending of the second link 125 occurs only at the spring portion 125b (that is, the base portion 125a does not bend). Furthermore, the spring portion 125b is drawn with a solid line in order to emphasize the bending of the spring portion 125b. Referring to FIGS. 7A and 7B, as the second link 125 is pulled by the lever frame 120 in an x direction, an end of the second link 125 is smoothly bent by a predetermined angle θ. The bending of the second link 125 corresponds to that of a cantilever having a fixed end and a free end as shown in FIG. 8. When equilibrium and geometric shape are considered, a bending member M and a deflection angle θ of the cantilever depicted in FIG. 8 correspond to a rotational moment applied to the axle 155 and a resultant rotation angle of the axle 155. Therefore, rotational stiffness K_{θ} derived from a moment-deflection equation of a cantilever (refer to Equation 2 below) can be used to determine the relationship between a rotational moment applied to the axle 155 and a resultant rotation angle of the axle 155.

$$M = \frac{EI}{l} θ \\ {K}_{θ} = \frac{EI}{l} \qquad [ Equation 2 ]$$

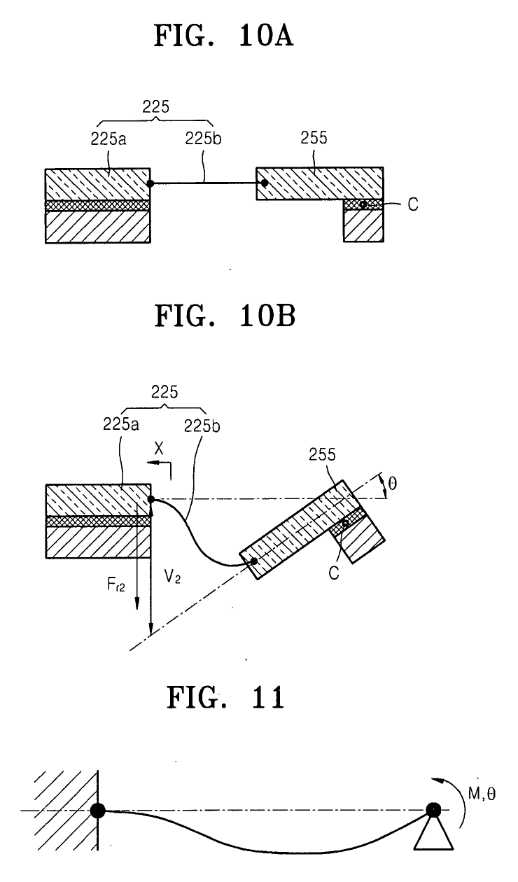

FIG. 9 is a plan view illustrating an example of an axle-link coupling structure for comparison to the axle-link structure of the exemplary embodiment of the present invention illustrated in FIG. 6. Referring to FIG. 9, an axle 255 of a stage 250 has a stripe shape extending straight in one direction. Second links 225 of a first actuator and a second actuator are coupled to both sides of the axle 255. The second links 225 are not formed across a centerline C of the axle 255. FIGS. 10A and 10B are vertical cross-sectional views taken along a line X-X of FIG. 9 and show the second link 225 before and after the axle 255 is rotated by a predetermined angle θ. As the second link 225 is pulled by a lever frame 120 in an x direction, the axle 255 is rotated by a predetermined angle θ about its centerline C, and the second link 225 is bent into an S-shape having opposite curvatures. One end of the second link 225 fixed to the axle 255 is bent by the same angle θ as the rotation angle θ of the axle 255. The bending of the second link 225 corresponds to that of a cantilever having a fixed end and a hinged end as shown in FIG. 11. When equilibrium and geometric shape are considered, a bending member M and a deflection angle θ of the hinged end of the cantilever depicted in FIG. 11 correspond to a rotational moment applied to the axle 255 and a resultant rotation angle of the axle 255. Therefore, rotational stiffness K_{θ} derived from a moment-deflection equation of a cantilever (refer to Equation 3 below) can be used to determine the relationship between a rotational moment applied to the axle 255 and a resultant rotation angle of the axle 255.

$$M = \frac{4 EI}{l} θ \\ {K}_{θ} = \frac{4 EI}{l} \qquad [ Equation 3 ]$$

Referring to Equations 2 and 3, the rotational stiffness K_{θ} of the second link structure of the exemplary embodiment of the present invention is ¼ of the rotational stiffness K_{θ} of the comparison example as shown in FIG. 9. Therefore, when the same moment is applied, the stage 150 of the exemplary embodiment of the present invention as illustrated in FIG. 6 can be rotated by an angle four times larger than that of the stage 250 of FIG. 9. In other words, even when the moment applied to the axle-link structure of the exemplary embodiment of the present invention is ¼ of the moment applied to the axle-link structure of the comparison example, the stage 150 of the present invention can be rotated by the same angle as the stage 250 of the comparison example.

Meanwhile, referring to FIGS. 7B and 10B, the bent second links 125 and 225 apply elastic restoring forces (pulling forces) Fr1 and Fr2 to the lever frame connected thereto. When the second link 125 of an exemplary embodiment of the present invention is compared to the second link 225 of the comparison example, a deflection V1 of the second link 125 measured in a vertical direction is much less than a deflection V2 of the second link 225 measured in the vertical direction. Therefore, since the elastic restoring forces Fr1 and Fr2 are proportional to the deflection V1 and V2, respectively, the elastic restoring force Fr1 of the second link 125 may be much less than the restoring force Fr2 of the second link 225. The elastic restoring forces Fr1 and Fr2 obstruct driving of the axle 155 as frictional forces. Furthermore, the elastic restoring forces Fr1 and Fr2 cause deformation of the lever frame and other connected elements in a vertical direction, thereby deteriorating coplanarity. In addition, the elastic restoring forces Fr1 and Fr2 can result in undesired vibrations followed by distortions and result in mechanical interferences and abrasions. However, the second link-axle coupling structure of the exemplary embodiment of the present invention minimizes the elastic restoring force of the second link, thereby ensuring smooth operation of the MEMS device.

Meanwhile, referring again to FIG. 2, a plurality of fixing anchors 160 are arranged along edges of the actuators 110 and 130. The fixing anchors 160 elastically support driving elements that are periodically translated or swung, so as to allow normal operation of the driving elements and prevent separation, undesired vibration, and deformation of the driving elements. For this, elastic springs 165 are disposed between the driving elements and the fixing anchors 160. For example, each of the elastic springs 165 disposed between the driving electrodes 111 and the fixing anchors 160 has a folded shape in the y direction for expansion and compression in the y direction, and has a high aspect ratio (narrow width) so as to allow the driving electrode 111 to translate in the y-axis direction and prevent the driving electrode 111 from moving in x- and z-axis directions.

The fixing anchors 160 may be formed inside the actuators 110 and 130 as well as along the edges of the actuators 110 and 130. For example, as shown in FIG. 2, the fixing anchors 160 are formed between the driving frame 115 and the lever frame 120, and the elastic springs 165 are formed between the driving frame 115 and the fixing anchors 160, and also between the lever frame 120 and the fixing anchors 160. In this case, the elastic springs 165 have a similar structure. That is, the elastic springs 165 have a folded shape in the y direction for expansion and compression in the y direction, and have a high aspect ratio (narrow width) for flexibility in only one direction (the y-axis direction). Since the driving frame 115 and the lever frame 120 are elastically supported by the fixing anchors 160 through the elastic springs 165, the driving frame 115 and the lever frame 120 can be moved in the y-axis direction but cannot be moved in x- and z-axis directions. Therefore, undesired vibration can be prevented and thus driving power can be saved. Furthermore, the overall coplanarity of the MEMS device can be maintained to prevent mechanical interferences and abrasions, thereby ensuring smooth operation of the MEMS device.

When the MEMS device is used in an optical scanner, one side of the stage 150 is used as a reflection surface. That is, while the stage 150 is swung, incident light is reflected in a scanning direction. The other side of the stage 150 is formed by a plurality of ribs 151 in a striped pattern as shown in FIG. 3. The stage 150 having a striped pattern can be formed by patterning a silicon substrate by using an etching process. The mass and moment of inertia of the stage 150 can be reduced by forming the ribs 151 on the stage 150, thereby obtaining rapid dynamic response and high driving efficiency. Furthermore, owing to the plurality of ribs 151, the strength and rigidity of the stage 150 can be increased and thus deformation of the stage 150 can be prevented.

The effects of an exemplary embodiment of the present invention can be clearly understood from results of a numerical analysis shown in Table 1 below. Table 1 compares driving voltages required for driving the MEMS device of the present exemplary embodiment and a related art MEMS device in the same resonant frequency and rotation angle range. Referring to Table 1, when the rotation angle range was ±12 degrees, and the resonant frequency was 25 kHz, a driving voltage Vp-p (peak to peak voltage) required for the MEMS of the present exemplary embodiment was 170 V, and a driving voltage Vp-p required for the related art MEMS device was 280V. That is, the MEMS device of the present exemplary embodiment requires half the driving voltage of the related art MEMS device. When the driving voltage is converted into power, the power consumption of the MEMS device of the present exemplary embodiment is ⅓ of that of the MEMS device of the related art MEMS device. In other words, when the same power is supplied, the MEMS device of the present exemplary embodiment can generate a driving force three times greater than the driving force generated by the related art MEMS device.

TABLE 1

| Performance items | Conventional | Present invention |
|---|---|---|
| Rotation angle | ±12° | ±12° |
| Resonant frequency | 25 kHz | 25 kHz |
| Mirror diameter | 1.6 mm | 1.8 mm |
| Driving voltage (Vp-p) | 280 V | 170 V |

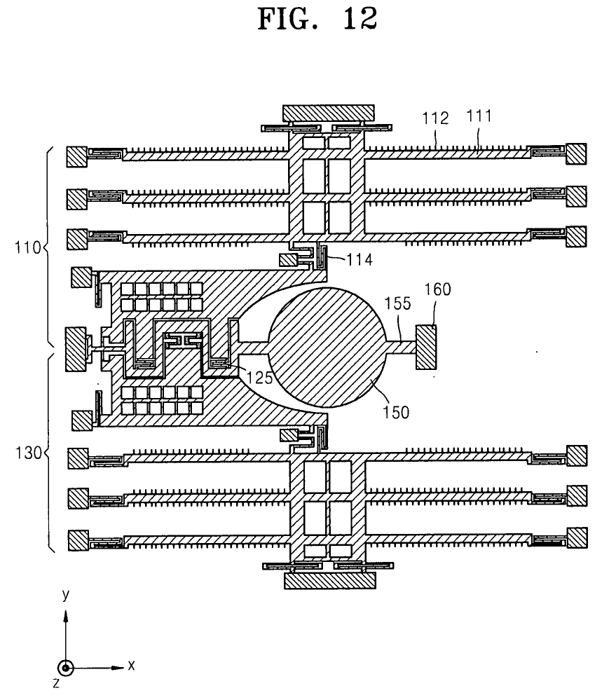

FIGS. 12 through 14 are plan views illustrating MEMS devices according to other exemplary embodiments of the present invention. In FIGS. 12 through 14, elements having substantially the same functions as in the exemplary embodiment illustrated in FIG. 2 are denoted by the same reference numerals, and fixed electrodes are not illustrated for clarity. Referring to FIG. 12, a MEMS device of another exemplary embodiment of the present invention includes a stage 150, an axle 155 supporting the stage 150 and allowing rotation of the stage 150, first and second actuators 110 and 130 applying exciting forces to the axle 155 in opposite directions. The first and second actuators 110 and 130 periodically apply push-pull exciting forces to the axle 155 at different heights in the z-axis direction so as to swing the stage 150 supported by the axle 155 forward and backward. Second links 125 of the first and second actuators 110 and 130 are connected to one end of the axle 155 in order to transmit the exciting forces of the first and second actuators 110 and 130 to the axle 155. The other end of the axle 155 is fixedly supported by a fixing anchor 160. In the current exemplary embodiment of the present invention, power is transmitted from the first and second actuators 110 and 130 only to one end of the axle 155 so as to simplify the power transmission structure. Therefore, an MEMS device having advantages in terms of integration and miniaturization can be provided.

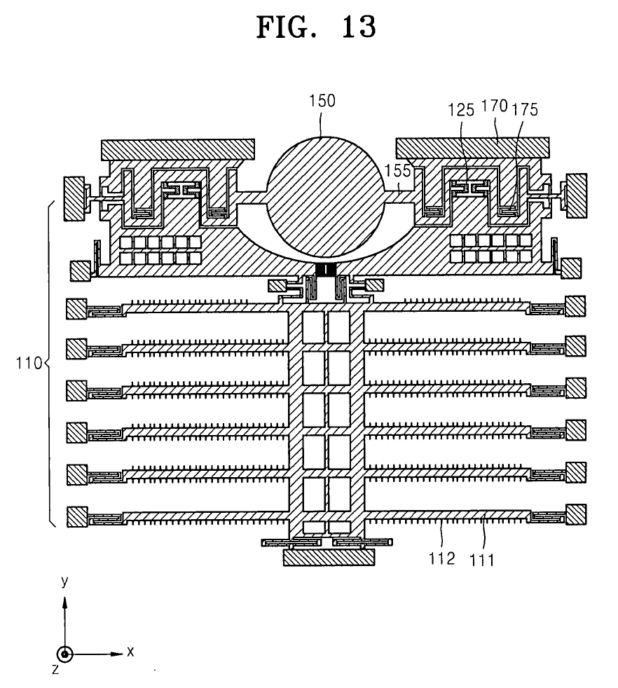

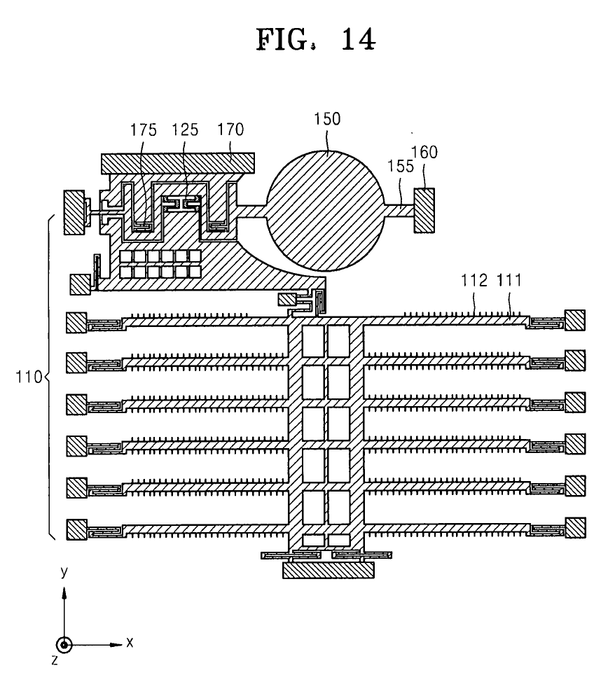

Referring to FIG. 13, a MEMS device of another exemplary embodiment of the present invention includes a stage 150 supported by an axle 155 and an actuator 110 applying an exciting force to the stage 150. Second links 125 extending from the actuator 110 are connected to the axle 155. Furthermore, fixed links 175 extending from a fixed frame 170 located at an opposite side to the actuator 110 are connected to the axle 155. The second links 125 and the fixed links 175 apply exciting forces to the axle 155 in opposite directions and at different height in the z-axis direction. That is, the actuator 110 applies a push-pull exciting force to the axle 155 through the second links 125, and the fixed links 175 applies a reaction force to the axle 155 against the push-pull exciting force of the actuator 110. Therefore, the exciting force and the reaction force are applied to the axle 155 in opposite directions and at different height in the z-axis direction, so that the axle 155 and the stage 150 are rotated by the coupled exciting force and reaction force. In the current exemplary embodiment of the present invention, the axle 155 is driven by only one actuator 110 so as to simplify the structure of the MEMS device. Therefore, an MEMS device having advantages in integration and miniaturization can be provided.

Referring to FIG. 14, a MEMS device of another exemplary embodiment of the present invention includes a stage 150 supported by an axle 155 and an actuator 110 actuating the stage 150. Second links 125 of the actuator 110 and fixed links 175 of a fixed frame 170 are connected to one end of the axle 155 in opposite directions in order to periodically apply exciting forces to the axle 155. The other end of the axle 155 is fixedly supported by a fixed anchor 160. In the current exemplary embodiment, only one actuator 110 is used, and power is transmitted from the actuator 110 to only one end of the axle 155, thereby simplifying the power transmission structure. Therefore, a smaller scanner chip can be provided.

In the MEMS devices of the exemplary embodiments of the present invention, translational vibration is generated by the in-plane comb structure, and the driving moment of the stage is obtained from the translational vibration using the translation-rotation converting mechanism. Since the driving moment of the stage is directly generated by the comb structure in the related art MEMS device, it is difficult to expand the comb structure because of restrictions of resonant conditions and geometry. Thus, a driving force and angle of a scanner are restricted. However, according to the exemplary embodiments of the present invention, the comb structure can be easily expanded. For example, the driving angle can be increased by simply adding more combs in the same plane, and thus a large screen can be simply provided. Furthermore, the comb structure providing a driving force is separated from the rotary structure including the stage, so that the moment of inertia of the stage can be reduced. Therefore, an improved scanner can be provided for high-speed and high-resolution display devices.

Furthermore, the mechanical lever structure is used to transmit an exciting force generated by the comb structure, so that the exciting force can be amplified. Moreover, the motion converting mechanism is used to link the actuators to the axle in different heights, thereby obtaining a high translation-rotation converting efficiency.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A micro-electro mechanical system (MEMS) device comprising:
a stage which is supported by an axle; and
an actuator which provides a push-pull exciting force to the axle at upper and lower eccentric positions of an axis of the axle,
wherein the actuator comprises:
a plurality of fixed combs which extend in parallel at intervals;
a plurality of driving combs for engagement with the fixed combs, the driving combs being translationally vibrated between an engaging position and a disengaging position by an electrostatic attractive force periodically generated by the fixed combs;
a driving frame which connects and supports the driving combs, the driving frame being vibrated together with the driving combs; and
a motion transmitting member which transmits the translational vibration of the driving frame to the eccentric positions of the axle.

2. The MEMS device of claim 1, wherein the motion transmitting member comprises:
a lever frame which interlocks with the driving frame so as to be rotationally vibrated about a hinged end within an angle range;
a first link which interlocks the lever frame with the driving frame; and
a second link which connects the lever frame to the eccentric positions of the axle.

3. The MEMS device of claim 2, wherein the lever frame is coupled to the first link at a point located a distance L1 from the hinged end and to the second link at a point located a distance L2 from the hinged end, and the distance L1 is greater than the distance L2.

4. The MEMS device of claim 2, wherein the second link extends from the lever frame, crosses a centerline of the axle, and couples to a concave portion of the axle corresponding to the second link.

5. The MEMS device of claim 1, wherein the driving frame comprises:
a plurality of driving electrodes which is arranged in parallel and on which the driving combs are arranged along a longitudinal direction; and
a connection bar which connects the driving electrodes.

6. A micro-electro mechanical system (MEMS) device comprising:
a stage which is supported by an axle; and
first and second actuators which are respectively located at first and second positions above and below an axis of the axle and apply forces to the axle in opposite directions,
wherein each of the first and second actuators comprises:
a plurality of fixed combs which extend at intervals in parallel to each other;
a plurality of driving combs for engagement with the fixed combs, the driving combs being translationally vibrated between an engaging position and a disengaging position by an electrostatic attractive force periodically generated by the fixed combs;
a driving frame which connects and supports the driving combs, the driving frame being vibrated together with the driving combs; and
a lever frame which interlocks with the driving frame through a first link so as to be rotationally vibrated about a hinged end; and
a second link which extends from one side of the lever frame toward the axle of the stage and is coupled to the first position or the second position of the axle.

7. The MEMS device of claim 6, wherein the second link rotates the axle forward and backward while applying a push-pull exciting force to an eccentric position of the axle.

8. The MEMS device of claim 6, wherein the lever frame is coupled to the first link at a point located a distance L1 from the hinged end and to the second link at a point located a distance L2 from the hinged end, and the distance L1 is greater than the distance L2.

9. The MEMS device of claim 6, wherein the second link extends from the lever frame, crosses a centerline of the axle, and couples to a concave portion of the axle formed as corresponding to the second link.

10. The MEMS device of claim 9, wherein the axle comprises a folded shape comprising a first concave portion and a second concave portion, the first concave portion being concaved corresponding to the second link of the first actuator, the second concave portion being concaved in an opposite direction to the first concave portion so as to correspond with the second link of the second actuator.

11. The MEMS device of claim 6, wherein the driving frame comprises:
a plurality of driving electrodes which are arranged in parallel to each other and on which the driving combs are arranged along a longitudinal direction; and
a connection bar which connects the driving electrodes.

12. The MEMS device of claim 11, wherein a fixed electrode is disposed between the driving electrodes, the fixed electrode being formed with the fixed combs in a length direction.

13. The MEMS device of claim 11, wherein the driving electrodes comprises:
a central driving electrode which is disposed at a center portion and has inner and outer surfaces formed with the driving combs;
an inner driving electrode which is disposed at an inner side of the central driving electrode and has an inner surface formed with the driving combs; and
an outer driving electrode which is disposed at an outer side of the central driving electrode and has an outer surface formed with the driving combs.

14. The MEMS device of claim 13, wherein the fixed combs are formed on surfaces of fixed electrodes facing the driving combs.

15. The MEMS device of claim 14, wherein the inner driving electrode periodically receives an attractive force in an inward direction due to an interaction between the driving combs and the fixed combs, and the outer electrode periodically receives an attractive force in an outward direction due to the interaction between the driving combs and the fixed combs.

16. The MEMS device of claim 11, wherein each of the driving electrodes comprises an elastic spring on an end, the elastic spring having a folded shape with a high aspect ratio so as to allow a translational vibration in one direction while being extended and compressed, and so as to restrict a motion in other directions.

17. The MEMS device of claim 6, wherein the hinged end of the lever frame is an equilibrium point on the axle to which the first actuator and the second actuator apply forces in opposite directions at a substantially same height.

18. The MEMS device of claim 6, wherein the MEMS device is obtained by etching an silicon-on-insulator (SOI) substrate into a predetermined pattern, the SOI substrate comprising a first conductive substrate, a second conductive substrate, and an insulating layer formed between the first and second conductive substrates.

19. The MEMS device of claim 18, wherein the second link of the first actuator is formed into a single layer in the first conductive substrate, the second link of the second actuator is formed into a single layer in the second conductive substrate, and the axle is formed into multiple layers in the first and second substrates.

20. The MEMS device of claim 18, wherein an end of the second link extending from the first actuator and an upper portion of the axle contacting the end of the second link are integrally formed in the first conductive substrate, and an end of the second link extending from the second actuator and a lower portion of the axle contacting the end of the second link extending from the second actuator are integrally formed in the second conductive substrate.

21. The MEMS device of claim 18, wherein the hinged end of the lever frame and portions of the first and second actuators contacting the hinged end of the lever frame are formed into multiple layers in the first and second conductive substrate.

22. The MEMS device of claim 6, wherein the first link comprises a spring member having a folded shape and a high aspect ratio.

23. The MEMS device of claim 6, wherein the second link comprises at least one spring portion having a folded shape and a high aspect ratio.

24. The MEMS device of claim 6, wherein the stage comprises a reflection surface and a reinforcement rib pattern formed on a surface opposite to the reflection surface.

25. The MEMS device of claim 6, wherein each of the first and second actuators are coupled to both ends of the axle so as to periodically provide an exciting force to the first and second positions of the axle.

26. The MEMS device of claim 6, wherein each of the first and second actuators is coupled to one end of the axle so as to periodically provide an exciting force to an eccentric position of the axle, and the other end of the axle is fixedly supported.

27. A micro-electro mechanical system (MEMS) device comprising:
a stage which is supported by an axle; and
an actuator and a fixed frame which are respectively located at first and second positions above and below an axis of the axle and apply forces to the axle in opposite directions,
wherein the actuator comprises:
a plurality of fixed combs which extend in one direction at intervals in parallel to each other;
a plurality of driving combs for engagement with the fixed combs, the driving combs being translationally vibrated between an engaging position and a disengaging position by an electrostatic attractive force periodically generated by the fixed combs;
a driving frame which connects and supports the driving combs, the driving frame being vibrated together with the driving combs; and
a lever frame which interlocks with the driving frame through a first link so as to be rotationally vibrated about a hinged end; and
a second link which extends from one side the lever frame toward the axle of the stage and is coupled to the first position of the axle,
wherein the fixed frame comprises a fixed link which is coupled to the second position of the axle for applying a reaction force to the axle against a force applied from the actuator to the axle.

28. The MEMS device of claim 27, wherein the axle comprises at least one folded portion comprising a first concave portion and a second concave portion, the first concave portion being concaved corresponding to the second link, the second concave portion being concaved in an opposite direction to the first concave portion so as to correspond with the fixed link.

29. The MEMS device of claim 27, wherein each of the actuator and the fixed frame is coupled to both ends of the axle so as to periodically apply an exciting force to the first and second positions of the axle.

30. The MEMS device of claim 27, wherein each of the actuator and the fixed frame is coupled to one end of the axle so as to periodically provide an exciting force to an eccentric position of the axle, and the other end of the axle is fixedly supported.
